(19) United States
(12) Patent Application Publication
(10) Pub. No.: US 2014/0362069 A1
(43) Pub. Date: Dec. 11, 2014

(54) DISPLAY APPARATUS AND DRIVING METHOD THEREOF

(71) Applicant: Au Optronics Corp., Hsin-Chu (TW)

(72) Inventors: Chun-Yen LIU, Hsin-Chu (TW); Shang-Heng HSIEH, Hsin-Chu (TW)

(73) Assignee: Au Optronics Corp., Hsin-Chu (TW)

(21) Appl. No.: 14/063,041

(22) Filed: Oct. 25, 2013

(30) Foreign Application Priority Data
Jun. 11, 2013 (TW) 102120756

(51) Int. Cl. G09G 3/14; G09G 3/32

(52) U.S. Cl. CPC G09G 3/14; G09G 3/3225
USPC 345/211; 345/76

(57) ABSTRACT

A display apparatus includes a first pixel, a second pixel and a driving circuit. The first pixel receives a first control signal and a first scan signal and a respective data signal in a first period according to the first scan signal. The second pixel receives the first control signal and a second scan signal in a second period and a respective data signal according to the second scan signal. The first and second periods are different to each other. The first and second pixels both include a light-emitting diode. The driving circuit is electrically coupled to the first and second pixels and provide the first and second scan signals and the first control signal, wherein the first control signal is used for determining whether to allow a current to flow through the respective light-emitting diodes or not. A driving method for a display apparatus is also provided.

### TECHNICAL FIELD

The present disclosure relates to a display apparatus, and more particularly to a pixel driving architecture of a display apparatus. The present disclosure also provides a driving method for the aforementioned display apparatus.

### BACKGROUND

To improve the electrical uneven issue of thin film transistors (TFT) in pixels, basically, the threshold voltage (Vth) compensation design is adopted in conventional organic light-emitting diode (OLED) pixel circuit architecture.

However, under this specific pixel circuit design, each pixel may requires a certain number of signals for a driving thereof, and accordingly a certain number of single lines for transmitting the aforementioned signals are needed to be arranged in a limited layout space. Thus, an associated conventional display apparatus may not have a slim border design.

### SUMMARY

An object of the present disclosure is to provide a display apparatus having a pixel driving architecture requiring a less number of driving signals.

Another object of the present disclosure is to provide a driving method for the aforementioned display apparatus.

The present disclosure provides a display apparatus, which includes a first pixel, a second pixel and a driving circuit. The first pixel receives a first control signal and a first scan signal and a respective data signal in a first period according to the first scan signal. The second pixel receives the first control signal and a second scan signal in a second period and a respective data signal according to the second scan signal. The first and second periods are different to each other. The first and second pixels both include a light-emitting diode. The driving circuit is electrically coupled to the first and second pixels and provide the first and second scan signals and the first control signal, wherein the first control signal is used for determining whether to allow a current to flow through the respective light-emitting diodes or not.

The present disclosure further provides a display apparatus, which includes a first pixel, a second pixel and a driving circuit. The first pixel is configured to receive a second control signal and a first scan signal and receive a data signal of the first pixel in a first period according to the first scan signal. The second pixel is configured to receive the second control signal and a second scan signal in a second period and receive a data signal of the second pixel according to the second scan signal. The first period is different with the second period. The first and second pixels both include a light-emitting diode and a second transistor. The second transistor is configured to control a magnitude of a current flowing through the light-emitting diode in the respective pixel according to a voltage difference between a gate and a source of the second transistor. The second control signal is used for determining whether or not to reset a voltage at the gate of the second transistor in the respective pixel to a predetermined voltage value. The driving circuit is electrically coupled to the first and second pixels and configured to provide the first scan signal, the second scan signal and the second control signal.

The present disclosure still further provides a driving method for a display apparatus. The display apparatus includes a first pixel and a second pixel. Both of the first and second pixels include a first transistor, a second transistor and a light-emitting diode. The first transistor is configured to determine whether or not to allow a current to flow through the light-emitting diode in the respective pixel according to a first control signal. The second transistor is configured to control a magnitude of the current flowing through the light-emitting diode in the respective pixel according to a voltage difference between a gate and a source of the second transistor. The driving method includes: cutting off, through the first control signal, the first transistors in the first and second pixels and thereby preventing a current from flowing through the light-emitting diodes in the first and second pixels; driving the first pixel in a first period to configure the first pixel to receive a data signal of the first pixel; driving the second pixel in a second period to configure the second pixel to receive a data signal of the second pixel, wherein the second period is different with the first period; and driving the first and second pixels to emit light according to the data signals thereof, respectively.

In summary, by sharing some specific signals to adjacent pixels, the pixel driving circuit can have a simpler circuit design and requires a less number of signal lines. Thus, the object of having a slimmer border design is achieved in the display apparatus of the present invention.

### BRIEF DESCRIPTION OF THE DRAWINGS

The present disclosure will become more readily apparent to those ordinarily skilled in the art after reviewing the following detailed description and accompanying drawings, in which:

FIG. 1 is a schematic circuit view of a light-emitting diode pixel of the present disclosure;

FIG. 2 is a timing sequence view illustrating the signals associated with any adjacent two rows of light-emitting diode pixels in FIG. 1 in accordance with the first embodiment of the present disclosure;

FIG. 3 is a schematic view of a display apparatus using the light-emitting diode pixels illustrated in FIG. 1 in accordance with the first embodiment of the present disclosure;

FIG. 4A is a timing sequence view illustrating the signals for driving each adjacent two rows of light-emitting diode pixels in FIG. 1 in accordance with the second embodiment of the present disclosure;

FIG. 4B is a timing sequence view illustrating the signals for driving each three successive rows of light-emitting diode pixels in FIG. 1 in accordance with the second embodiment of the present disclosure;

FIG. 5 is a schematic view of a display apparatus using the light-emitting diode pixels illustrated in FIG. 1 in accordance with the second embodiment of the present disclosure;

FIG. 6 is a flowchart illustrating a driving method for a display apparatus in accordance with an embodiment of the present disclosure;

FIG. 7 is a schematic view illustrating a circuit layout of two adjacent pixels in a display apparatus of the present invention; and

FIG. 8 is a schematic view illustrating a circuit design comparison between parts of display apparatus in prior art and the present invention.

### DETAILED DESCRIPTION OF PREFERRED EMBODIMENTS

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

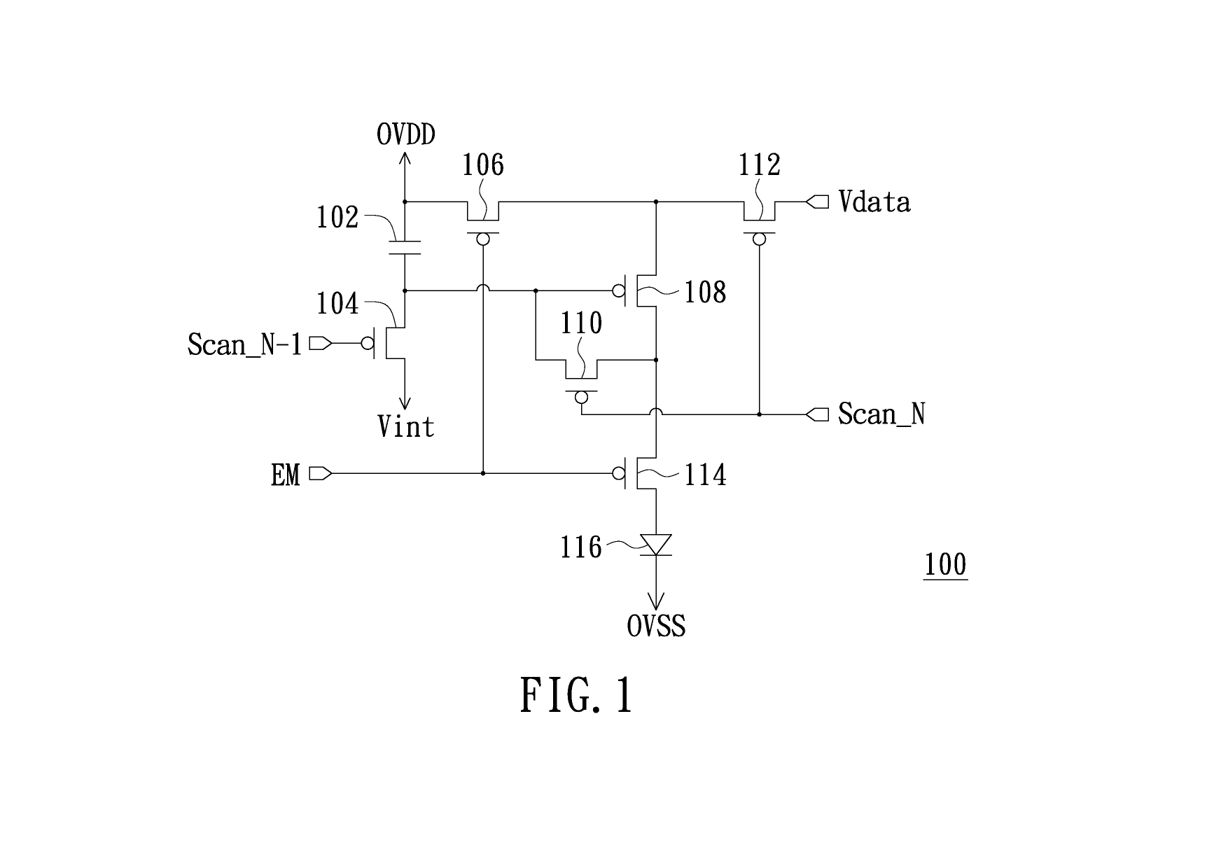

FIG. 1 is a schematic circuit view of a light-emitting diode pixel of the present disclosure. As shown, the light-emitting diode pixel 100, with a threshold voltage Vth compensation design, includes a capacitor 102, a light-emitting diode 116 and transistors 104, 106, 108, 110, 112 and 114. In one embodiment, the light-emitting diode 116 is an organic light-emitting diode; and the transistors 104, 106, 108, 110, 112 and 114 are P-type thin film transistors.

As shown in FIG. 1, specifically, the transistor 104 is configured to have one source/drain thereof electrically coupled to a power voltage OVDD through the capacitor 102; another source/drain thereof electrically coupled to a predetermined voltage Vint; and a gate thereof for receiving a control signal Scan_N−1. The transistor 106 is configured to have one source/drain thereof electrically coupled to the power voltage OVDD; and a gate thereof for receiving a control signal EM. The transistor 108 is configured to have one source/drain thereof electrically coupled to another source/drain of the transistor 106; and a gate thereof electrically coupled to the power voltage OVDD through the capacitor 102. The transistor 110 is configured to have one source/drain thereof electrically coupled to the gate of the transistor 108; another source/drain thereof electrically coupled to another source/drain of the transistor 108; and a gate thereof for receiving a scan signal Scan_N.

The transistor 112 is configured to have one source/drain thereof electrically coupled to the power voltage OVDD through the transistor 106; another source/drain thereof for receiving a data signal Vdata; and a gate thereof for receiving the scan signal Scan_N. The transistor 114 is configured to have one source/drain thereof electrically coupled to both of another source/drain of the transistor 108 and another source/drain of the transistor 110; another source/drain thereof electrically coupled to a reference voltage OVSS through the light-emitting diode 116; and a gate thereof for receiving the control signal EM. In this embodiment, N is a natural number.

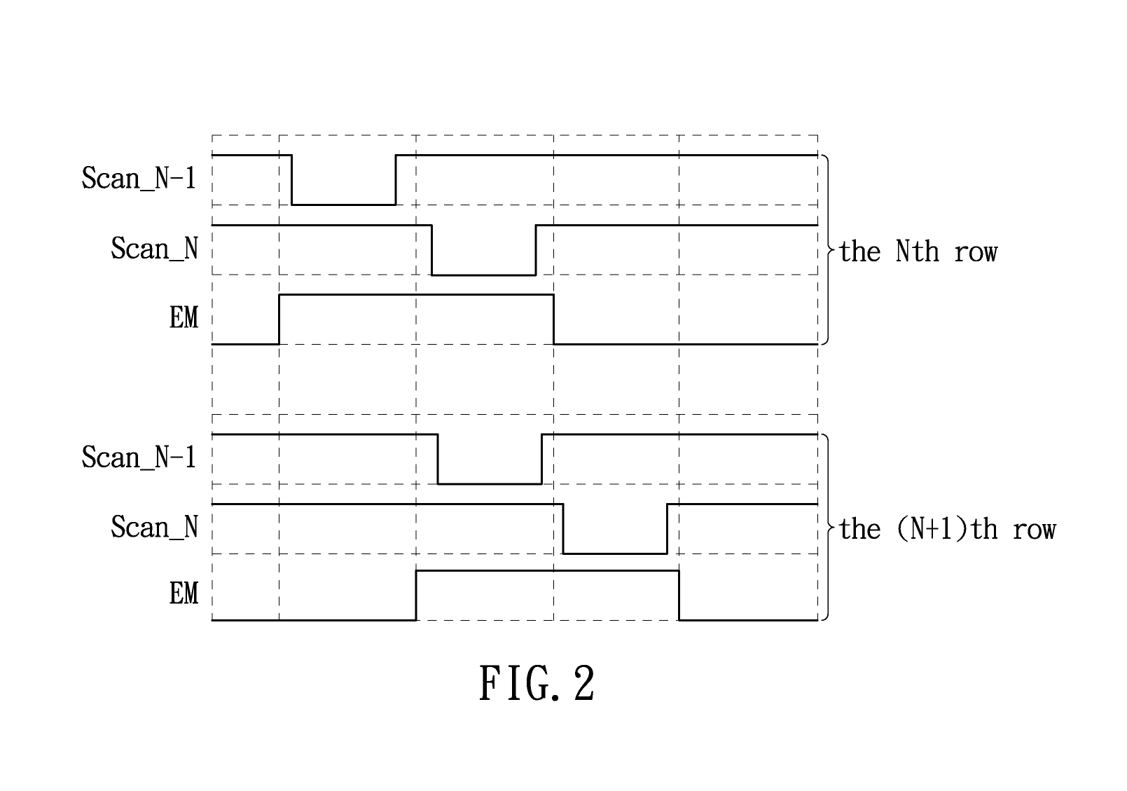

FIG. 2 is a timing sequence view illustrating the signals associated with any adjacent two rows of light-emitting diode pixels 100 shown in FIG. 1 in accordance with the first embodiment of the present disclosure. Specifically, the exemplarily control signal Scan_N−1, the scan signal Scan_N and the control signal EM in the upper half of FIG. 2 are used for the driving of the Nₜₕ pixel row; and the exemplarily control signal Scan_N−1, the scan signal Scan_N and the control signal EM in the lower half of FIG. 2 are used for the driving of the (N+1)ₜₕ pixel row.

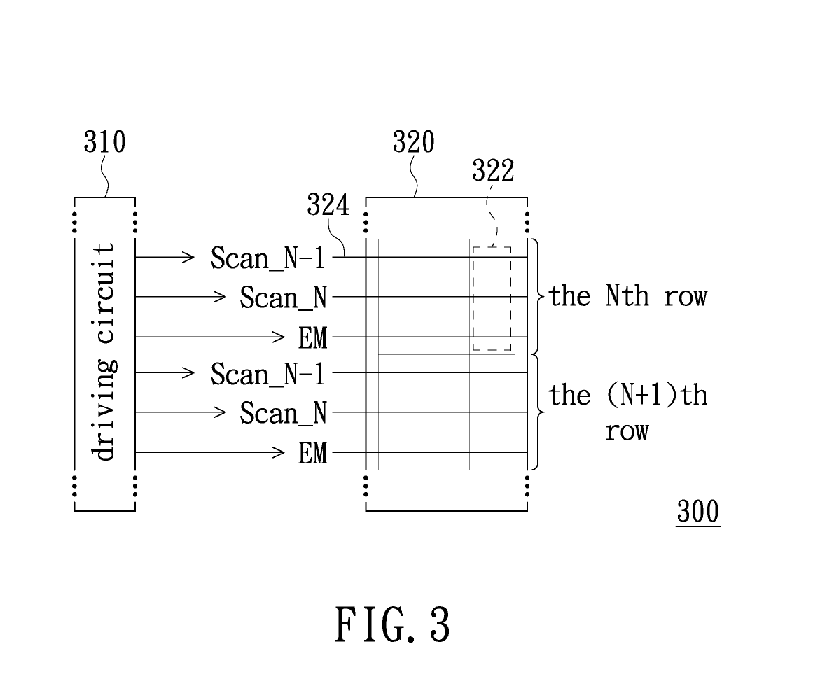

FIG. 3 is a schematic view of a display apparatus in accordance with the first embodiment of the present disclosure. As shown, the display apparatus 300 in this embodiment includes a driving circuit 310 and a display panel 320. The display panel 320 includes a plurality of pixels 322 and a plurality of signal lines 324; wherein the pixel 322 may have a circuit architecture same as that of the light-emitting diode pixel 100 illustrated in FIG. 1. Through the signal lines 324, the driving circuit 310 is electrically coupled to the respective rows of pixels 322 in the display panel 320. To get a clear understanding of the embodiment, the display panel 320 shown in FIG. 3 is exemplified by including two adjacent rows of pixels 322 only; and accordingly only the signals associated with the two adjacent rows of pixels 322 are depicted in FIG. 3. As shown in FIG. 3, both of the Nₜₕ and (N+1)ₜₕ rows of pixel 322 are configured to receive a control signal Scan_N−1, a scan signal Scan_N and a control signal EM. In other words, each two adjacent rows of pixels 322 need to be electrically coupled to six signal lines; and accordingly the border of the display panel 320 needs a relatively large room for the layout of these signals 324.

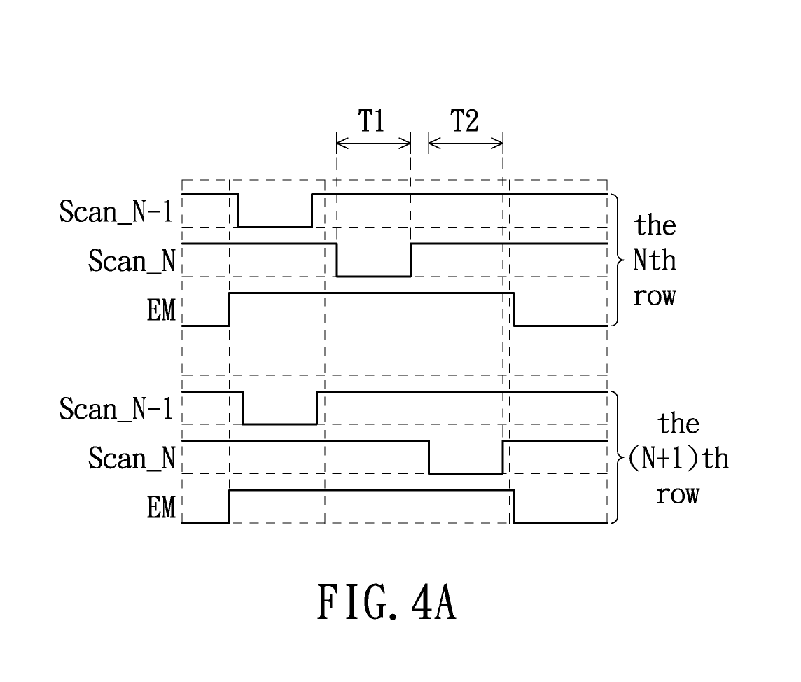

FIG. 4A is a timing sequence view illustrating the signals for driving each two adjacent rows of light-emitting diode pixels 100 in FIG. 1 in accordance with the second embodiment of the present disclosure. Similarly, the exemplarily control signal Scan_N−1, the scan signal Scan_N and the control signal EM in the upper half of FIG. 4A are used for the driving of the Nₜₕ pixel row; and the exemplarily control signal Scan_N−1, the scan signal Scan_N and the control signal EM in the lower half of FIG. 4A are used for the driving of the (N+1)ₜₕ pixel row.

Please refer to FIGS. 4 and 1 both. As shown, each light-emitting diode pixel 100 in the Nₜₕ pixel row is configured to receive the control signal Scan_N−1, scan signal Scan_N and control signal EM and also configured to receive the data signal Vdata in a period T1 according to the scan signal Scan_N. Similarly, each light-emitting diode pixel 100 in the (N+1)ₜₕ pixel row is configured to receive the control signal Scan_N−1, scan signal Scan_N and control signal EM and also configured to receive the data signal Vdata in a period T2 according to the scan signal Scan_N; wherein the period T1 is different to the period T2.

Specifically, as shown in FIGS. 4 and 1, the transistors 114 in the light-emitting diode pixel 100 is configured to determine to whether allow a current to flow thought the light-emitting diode 116 or not according to the control signal EM. In other words, the transistors 114 is configured to either switch on or off a current path formed between the transistor 108 and the light-emitting diode 116 according to the control signal EM. The transistor 108 in the light-emitting diode pixel 100 is configured to determine the magnitude of the current flowing through the light-emitting diode 116 according to the voltage difference between the gate and source thereof; wherein it is understood that the voltage difference between the gate and source of the transistor 108 varies with the data signal Vdata received by the respective light-emitting diode pixel 100. The control signal Scan_N−1 is used for determining whether or not to reset the gate voltage of the transistor 108 to the predetermined voltage Vint.

Please refer to FIG. 4A again. According to the signal timing sequence relationship illustrated in FIG. 4A, it is to be noted that the scan signal Scan_N, received by the Nₜₕ pixel row, is configured to have the starting edge of a pulse thereof located after the ending edge of a pulse of the control signal Scan_N−1 received by the Nₜₕ pixel row. The scan signal Scan_N, received by the (N+1)ₜₕ pixel row, is configured to have the starting edge of a pulse thereof located after the ending edge of a pulse of the scan signal Scan_N received by the Nₜₕ pixel row. The control signal EM is configured to have the starting edge of a pulse thereof located before the starting edge of a pulse of the control signal Scan_N−1 and the ending edge of the pulse thereof located after the ending edge of a pulse of the scan signal Scan_N received by the (N+1)ₜₕ pixel row.

In another embodiment, the scan signal Scan_N, received by the Nₜₕ pixel row, is configured to have the starting edge of a pulse thereof located at the ending edge of a pulse of the control signal Scan_N−1 received by the Nₜₕ pixel row. The scan signal Scan_N, received by the (N+1)ₜₕ pixel row, is configured to have the starting edge of a pulse thereof located at the ending edge of a pulse of the scan signal Scan_N received by the Nₜₕ pixel row. The control signal EM is configured to have the starting edge of a pulse thereof located at the starting edge of a pulse of the control signal Scan_N−1 and the ending edge of the pulse thereof located at the ending edge of a pulse of the scan signal Scan_N received by the (N+1)ₜₕ pixel row. In other words, the configurations of the control signal Scan_N−1, the scan signal Scan_N and the control signal EM of the present disclosure have to satisfy the following conditions: the control signal EM is configured to have a pulse enable time thereof completely covering the pulse enable times of the control signal Scan_N−1, the scan signal Scan_N received by the Nₜₕ pixel row and the scan signal Scan_N received by the (N+1)ₜₕ pixel row; the scan signal Scan_N received by the Nₜₕ pixel row and the scan signal Scan_N received by the (N+1)ₜₕ pixel row are configured to have no pulse enable time overlap therebetween.

In addition, by being compared with FIG. 2, it is to be noted that in FIG. 4A the control signal Scan_N−1 received by the Nₜₕ pixel row is modulated to have a timing sequence same as that received by the (N+1)ₜₕ pixel row has; and the control signal EM is configured to have the pulse enable time thereof completely covering the pulse enable times of the two control signals Scan_N−1, the scan signal Scan_N received by the Nₜₕ pixel row and the scan signal Scan_N received by the (N+1)ₜₕ pixel row Thus, in the embodiment as illustrated in FIG. 4A, the Nₜₕ and (N+1)ₜₕ pixel rows may corporately share one same control signal Scan_N−1 and one same control signal EM.

In one embodiment, the Nₜₕ and (N+1)ₜₕ pixel rows may corporately share one same control signal Scan_N−1 and each still have an individual control signal EM. In another embodiment, the Nₜₕ and (N+1)ₜₕ pixel rows may corporately share one same control signal EM and each still have an individual control signal Scan_N−1.

Specifically, if the Nₜₕ and (N+1)ₜₕ pixel rows corporately shares one same control signal EM, the control signal Scan_N−1 received by the (N+1)ₜₕ pixel row is configured to have a starting edge of a pulse thereof located at or after the ending edge of a pulse of the control signal Scan_N−1 received by the Nₜₕ pixel row.

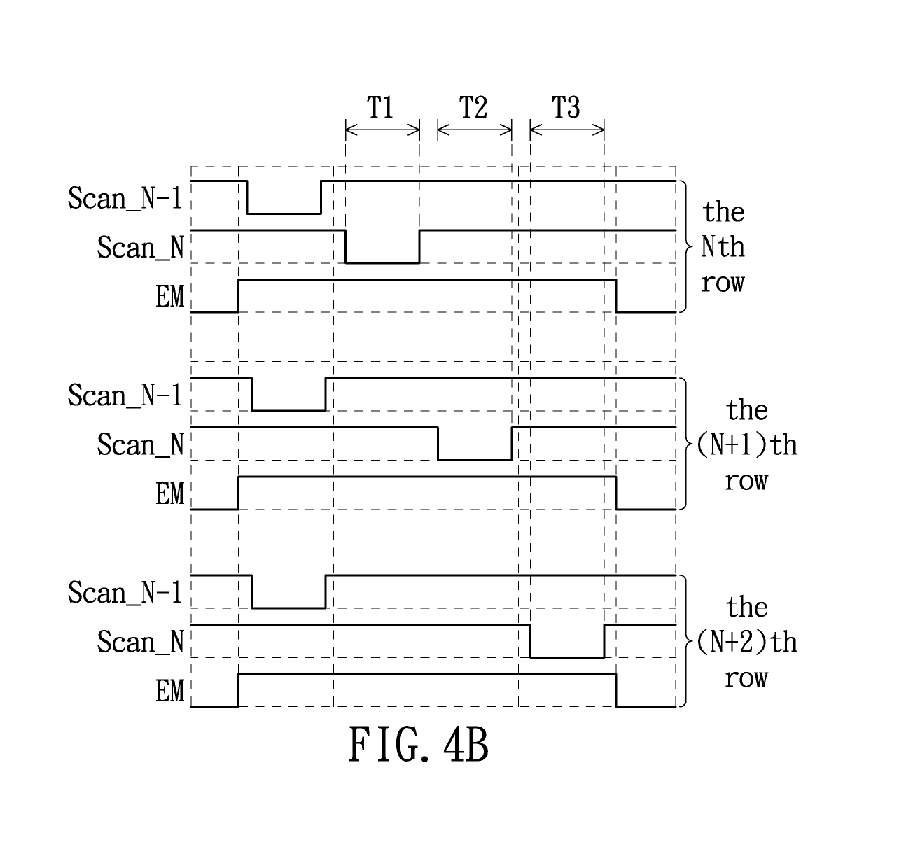

According to the signal timing sequences as illustrated in FIG. 4A, it is understood that the driving circuit for the Nₜₕ and (N+1)ₜₕ pixel rows may be simplified correspondingly and the circuit size of the driving circuit may be reduced accordingly. Thus, the display panel of the display apparatus of the present invention can have a slimmer border. In addition, the concept of the present invention is not necessary to be restricted to apply to two adjacent pixel rows; in other words, by sharing a signal to any two pixel rows without being adjacent to each other based on the aforementioned concept of the present invention, a slimmer border is also achieved. In addition, the number of signal lines for each two adjacent pixel rows is accordingly reduced in the present invention, and the detail description will be described in FIG. 5.

Moreover, the aforementioned embodiment is exemplified by driving each two adjacent rows of light-emitting diode pixels 100. However, it is understood that the characteristic of the present disclosure also applies to more than two rows of light-emitting diode pixels 100, as illustrated in FIG. 4B, which is a timing sequence view illustrating the signals for driving each three successive rows of light-emitting diode pixels 100 in accordance with the second embodiment of the present disclosure. As illustrated in FIG. 4B, the scan signal Scan_N, received by the Nₜₕ pixel row, is configured to have the starting edge of a pulse thereof located after the ending edge of a pulse of the control signal Scan_N−1 received by the Nₜₕ pixel row. The scan signal Scan_N, received by the (N+1)ₜₕ pixel row, is configured to have the starting edge of a pulse thereof located after the ending edge of a pulse of the scan signal Scan_N received by the Nₜₕ pixel row. The scan signal Scan_N, received by the (N+2)ₜₕ pixel row, is configured to have the starting edge of a pulse thereof located after the ending edge of a pulse of the scan signal Scan_N received by the (N+1)ₜₕ pixel row. The control signal EM is configured to have the starting edge of a pulse thereof located before the starting edge of a pulse of the control signal Scan_N−1 and the ending edge of the pulse thereof located after the ending edge of a pulse of the scan signal Scan_N received by the (N+2)ₜₕ pixel row. The configuration of the signals illustrated in FIG. 4B is similar to that in FIG. 4A, and no redundant detail is to be given herein.

FIG. 5 is a schematic view of a display apparatus in accordance with the second embodiment of the present disclosure. As shown, the display apparatus 500 in this embodiment includes a driving circuit 510 and a display panel 520. The display panel 520 includes a plurality of pixels 522 and a plurality of signal lines 524. In this embodiment, the pixel 522 may have a circuit structure same as that of the light-emitting diode pixel 100 as illustrated in FIG. 1, or, have other circuit structures with a threshold voltage Vth compensation design. In addition, through the signal lines 524, the driving circuit 510 is electrically coupled to the respective rows of pixels 522 in the display panel 520.

To get a clear understanding of the embodiment, the display panel 520 shown in FIG. 5 is exemplified by including four adjacent rows of pixels 522 only; and accordingly only the signals associated with these four adjacent rows of pixels 522 are depicted in FIG. 5. Among the signals outputted from the driving circuit 510, the control signals EM[n] and EM[n+2] both are used for controlling the transistor 114 in the pixel 522 to either allow a current to flow thought the light-emitting diode 116 or not. The control signal Scan_N−1[n] and Scan_N−1[n+2] both are used for either resetting the gate voltage of the transistor 108 to the predetermined voltage Vint or not. The scan signals Scan_N−1[n], Scan_N−1[n+1], Scan_N−1[n+2] and Scan_N−1[n+3] all are used for controlling the pixel 522 to either receive the data signal Vdata or not. In this embodiment, N and n both are natural numbers.

As shown in FIG. 5, the Nₜₕ row of pixel 522 are configured to receive a control signal EM[n], a scan signal Scan_N[n] and a control signal Scan_N−1[n]; and the (N+1)ₜₕ row of pixel 522 are configured to receive a control signal Scan_N−1[n], a scan signal Scan_N[n+1] and a control signal EM[n]. Because the Nₜₕ and (N+1)ₜₕ pixel rows can corporately share one same control signal Scan_N−1[n], the signal lines 524 for respectively transmitting the control signal EM[n], scan signal Scan_N[n], scan signal Scan_N[n+1] and control signal EM[n] may have a symmetrical arrangement relative to the signal line 524 for transmitting the control signal Scan_N−1[n] and accordingly only five signal lines 524 are needed for the Nₜₕ and (N+1)ₜₕ pixel rows. In another embodiment, it is understood that the Nₜₕ and (N+1)ₜₕ pixel rows may corporately share one same control signal EM[n], and accordingly the signal lines 524 for respectively transmitting the remaining signals may have a symmetrical arrangement relative to the signal line 524 for transmitting the control signal EM[n] and accordingly still only five signal lines 524 are needed for the Nₜₕ and (N+1)ₜₕ pixel rows.

Similarly, the (N+2)ₜₕ row of pixel 522 are configured to receive a control signal EM[n+2], a scan signal Scan_N[n+2] and a control signal Scan_N−1[n+2]; and the (N+3)ₜₕ row of pixel 522 are configured to receive a control signal Scan_N−1[n+2], a scan signal Scan_N[n+3] and a control signal EM[n+2]. Because the (N+2)ₜₕ and (N+3)ₜₕ pixel rows can corporately share one same control signal Scan_N−1[n+2], the signal lines 524 for respectively transmitting the remaining signals may have a symmetrical arrangement relative to the signal line 524 for transmitting the control signal Scan_N−1[n+2] and accordingly only five signal lines 524 are needed for the (N+2)ₜₕ and (N+3)ₜₕ pixel rows.

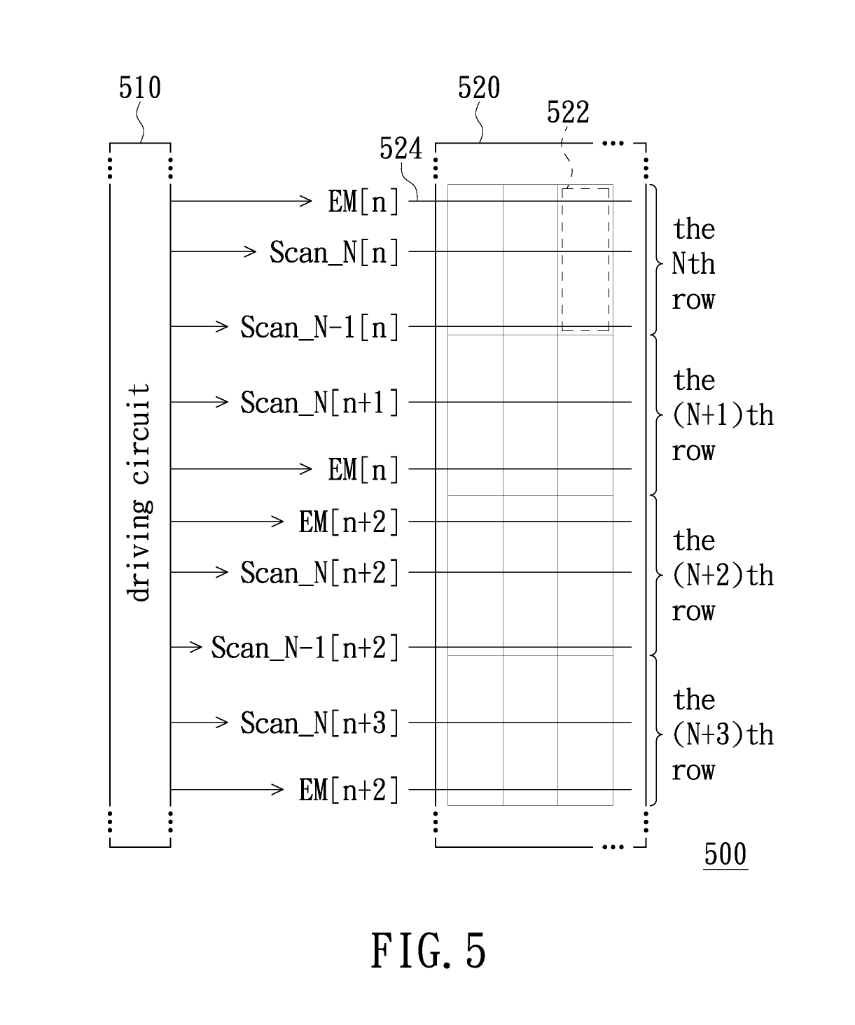

FIG. 6 is a flowchart illustrating a driving method for a display apparatus in accordance with an embodiment of the present disclosure. The display apparatus includes a first pixel and a second pixel. The first and second pixels both include a first transistor, a second transistor and a light-emitting diode. Specifically, the first transistor is configured to determine to whether allow a current to flow thought the light-emitting diode or not according to a first control signal. The second transistor is configured to determine the magnitude of the current flowing through the light-emitting diode according to the voltage difference between the gate and source thereof.

As illustrated in FIG. 6, the driving method includes steps of: switching off, through the first control signal (i.e., the aforementioned control signals EM), the first transistors in the first and second pixels and thereby preventing a current from flowing through the light-emitting diodes in the first and second pixels (step S602); driving the first pixel in a first period to configure the first pixel to receive a respective data signal (step S604); driving the second pixel in a second period to configure the second pixel to receive a respective data signal, wherein the second period is different with the first period (step S606); driving the first and second pixels to emit light according to the data signals thereof, respectively (step S608).

Furthermore, the aforementioned driving method may further include a step of: driving, through the second control signal (i.e., the aforementioned control signal Scan_N−1), the first and second pixels to rest gate voltages of the second transistors in the first and second pixels respectively before the first and second periods.

The light-emitting diode pixel 100 is taken as an example for the descriptions of the aforementioned embodiments; however, it is understood that the present disclosure is not limited thereto. In other words, the concept of the present disclosure may also apply to the light-emitting diode pixel with other circuit structures. For example, for the pixel circuit requiring one control signal EM[n] for determining whether or not to allow a current to flow through a light-emitting diode and one scan signal Scan_N for controlling a respective pixel to receive a data signal or not, the scan signal, received by the (N+1)ₜₕ pixel row, is configured to have a starting edge of a pulse thereof located at or after an ending edge of a pulse of the scan signal received by the Nₜₕ pixel row; the control signal, received by both of the Nₜₕ and (N+1)ₜₕ pixel rows, is configured to have a starting edge of a pulse thereof located at or before the starting edge of the pulse of the scan signal received by the Nₜₕ pixel row; and the control signal, received by both of the Nₜₕ and (N+1)ₜₕ pixel rows, is further configured to have an ending edge of the pulse thereof located at or after an ending edge of the pulse of the scan signal received by the (N+1)ₜₕ pixel row.

In summary, for the two adjacent pixel rows, the control signal is configured to have a pulse enable time completely covering that of the scan signal, and the pulse enable times of the scan signals for the Nₜₕ and (N+1)ₜₕ pixel rows do not overlap to each other.

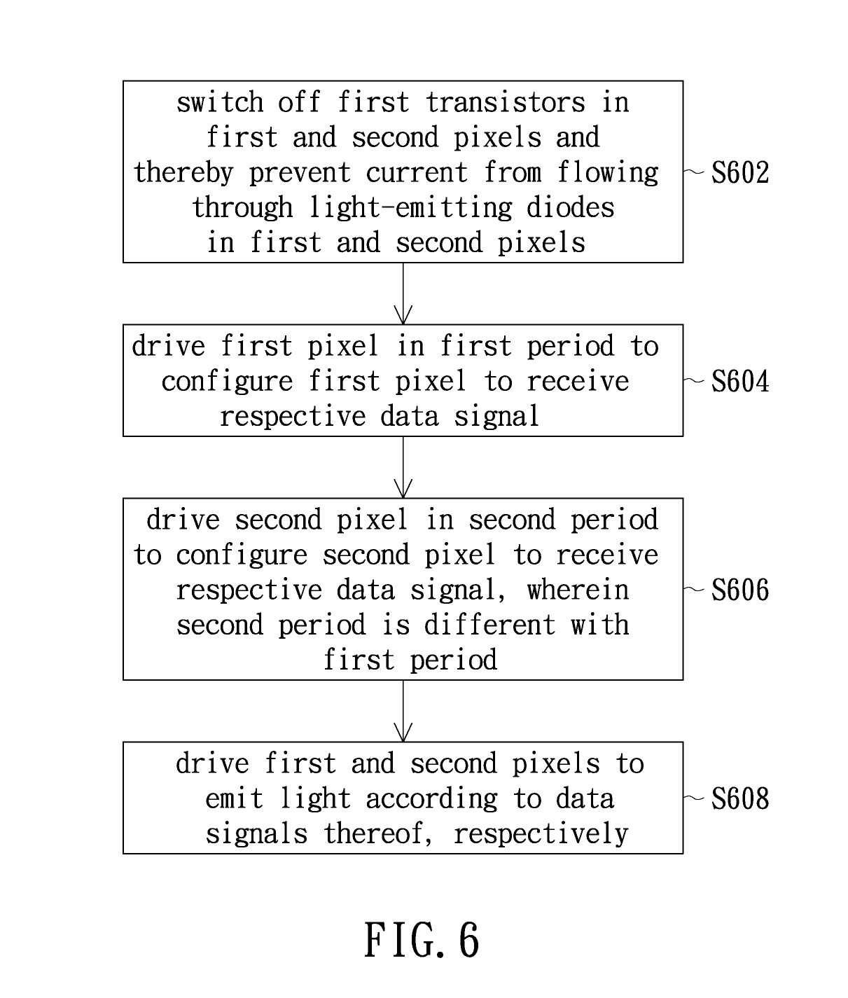

FIG. 7 is a schematic view illustrating a circuit layout of two adjacent pixels in a display apparatus of the present invention. As shown, the pixels 702, 704, arranged in the same column and two adjacent rows, totally needs five signal lines 706, 708, 710, 712 and 714; wherein the signal line 710 is shared by the two pixels 702, 704. In addition, the pixels 702, 704 have a symmetrical arrangement by referring the signal line 710 as a symmetrical axis and are configured to receive control signals via the signal line 710 located in an area between the pixels 702, 704. In one embodiment, the signal line 720 is used for transmitting the control signal Scan_N−1 for both of the pixels 720, 704; the signal lines 706, 714 are used for transmitting the control signals EM; and the signal lines 708, 712 are used to transmitting the respective scan signals Scan_N for the pixels 702, 704. In another embodiment, the signal line 710 is used for transmitting the control signal EM for both of the pixels 702, 704; the signal lines 706, 714 are used for transmitting the control signals Scan_N−1; and the signal lines 708, 712 are used to transmitting the respective scan signals Scan_N for the pixels 702, 704.

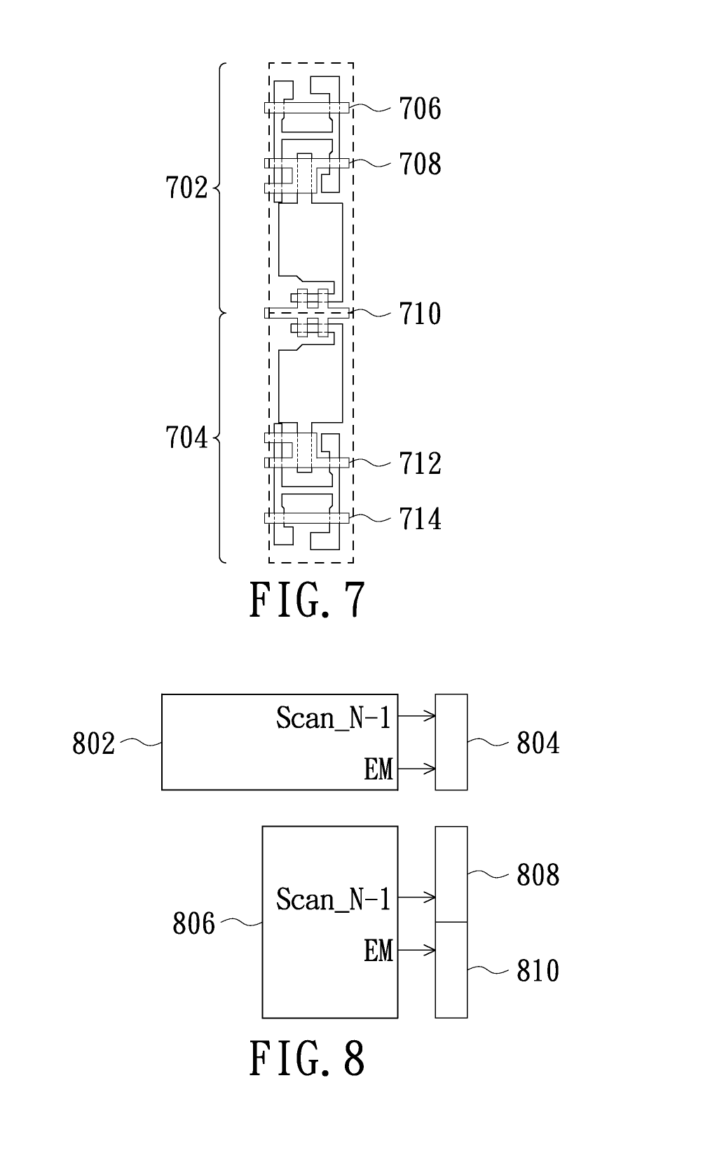

FIG. 8 is a schematic view illustrating a circuit design comparison between the display apparatuses in prior art and the present disclosure; wherein the upper part in FIG. 8 illustrates the circuit design in prior art and the lower half illustrates that of the present disclosure. As shown, each pixel 804 in prior art requires an individual control signal Scan_N−1 and an individual control signal EM, which are provided by the driving circuit 802. On the contrary, the two adjacent pixels 808, 810 of the present disclosure can corporately share one control signal Scan_N−1 and one control signal EM, which are provided by the driving circuit 806. Because requiring less number of signal lines, the driving circuit 806 can have a simpler circuit layout and accordingly the associated display apparatus can have a slimmer border design.

In summary, by sharing some specific signals to adjacent pixel rows, the pixel driving circuit can have a simpler circuit design and require a less number of signal lines. Thus, the objective of having a slimmer border design is achieved in the display apparatus of the present invention.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A display apparatus, comprising:
a first pixel configured to receive a first control signal and a first scan signal and receive a data signal of the first pixel in a first period according to the first scan signal;
a second pixel configured to receive the first control signal and a second scan signal in a second period and receive a data signal of the second pixel according to the second scan signal, wherein the first period is different with the second period, and the first and second pixels both comprise a light-emitting diode; and
a driving circuit electrically coupled to the first and second pixels and configured to provide the first scan signal, the second scan signal and the first control signal, wherein the first control signal is used for determining whether to allow a current to flow through the respective light-emitting diodes or not.

2. The display apparatus according to claim 1, wherein the second scan signal is configured to have a starting edge of a pulse thereof located at or after an ending edge of a pulse of the first scan signal; the first control signal is configured to have a starting edge of a pulse thereof located at or before the starting edge of the pulse of the first scan signal; and the first control signal is further configured to have an ending edge of the pulse thereof located at or after an ending edge of the pulse of the second scan signal.

3. The display apparatus according to claim 2, wherein both of the first and second pixels comprise a first transistor electrically coupled to the light-emitting diode in the respective pixel and configured to determine whether or not to allow the current to flow through the light-emitting diode in the respective pixel according to the first control signal.

4. The display apparatus according to claim 3, wherein both of the first and second pixels further comprise a second transistor electrically coupled to the respective first transistor and configured to control a magnitude of the current flowing through the light-emitting diode in the respective pixel according to a voltage difference between a gate and a source of the second transistor.

5. The display apparatus according to claim 4, wherein both of the first and second pixels are further configured to receive a second control signal provided by the driving circuit, the second control signal is used for determining whether or not to reset a voltage at the gate of the second transistor in the respective pixel to a predetermined voltage value.

6. The display apparatus according to claim 5, wherein the second control signal is configured to have a starting edge of a pulse thereof located at or after a starting edge of a pulse of the first control signal and an ending edge of the pulse thereof located at or after an ending edge of the pulse of the first control signal.

7. The display apparatus according to claim 3, wherein the first and second pixels are disposed in two adjacent rows, respectively.

8. The display apparatus according to claim 7, further comprising:
a first signal line for transmitting the first control signal, wherein the first and second pixels have a symmetrical arrangement by referring the first signal line as a symmetrical axis, and the first and second pixels receive the first control signal through the first signal line located in an area between the first and second pixels.

9. The display apparatus according to claim 1, wherein both of the first and second pixels comprise a first transistor electrically coupled to the light-emitting diode in the respective pixel and configured to determine whether or not to allow the current to flow through the light-emitting diode in the respective pixel according to the first control signal.

10. The display apparatus according to claim 9, wherein both of the first and second pixels further comprise a second transistor electrically coupled to the respective first transistor and configured to control a magnitude of the current flowing through the light-emitting diode in the respective pixel according to a voltage difference between a gate and a source of the second transistor.

11. The display apparatus according to claim 10, wherein both of the first and second pixels are further configured to receive a second control signal provided by the driving circuit, the second control signal is used for determining whether or not to reset a voltage at the gate of the second transistor in the respective pixel to a predetermined voltage value.

12. The display apparatus according to claim 11, further comprising:
a third pixel row configured to receive a third scan signal and the second control signal,
wherein the third scan signal is configured to have a starting edge of a pulse thereof located at or after an ending edge of a pulse of the second scan signal and an ending edge of a pulse thereof located at or before an ending edge of a pulse of the first control signal. the first scan signal is configured to have a starting edge of a pulse thereof located at or after an ending edge of a pulse of the second control signal.

13. The display apparatus according to claim 9, wherein the first and second pixels are disposed in two adjacent rows, respectively.

14. The display apparatus according to claim 13, further comprising a first signal line configured to transmit the first control signal, wherein the first and second pixels have a symmetrical arrangement by referring the first signal line as a symmetrical axis, and the first and second pixels receive the first control signal through the first signal line located in an area between the first and second pixels.

15. A display apparatus, comprising:
a first pixel configured to receive a second control signal and a first scan signal and receive a data signal of the first pixel in a first period according to the first scan signal;
a second pixel configured to receive the second control signal and a second scan signal in a second period and receive a data signal of the second pixel according to the second scan signal, wherein the first period is different with the second period, the first and second pixels both comprise a light-emitting diode and a second transistor, the second transistor is configured to control a magnitude of a current flowing through the light-emitting diode in the respective pixel according to a voltage difference between a gate and a source of the second transistor, and the second control signal is used for determining whether or not to reset a voltage at the gate of the second transistor in the respective pixel to a predetermined voltage value; and
a driving circuit electrically coupled to the first and second pixels and configured to provide the first scan signal, the second scan signal and the second control signal.

16. The display apparatus according to claim 15, wherein the first scan signal is configured to have a starting edge of a pulse thereof located at or after an ending edge of a pulse of the second control signal; and the second scan signal is configured to have a starting edge of a pulse thereof located at or after an ending edge of the pulse of the first scan signal.

17. The display apparatus according to claim 16, further comprising:
a second signal line for transmitting the second control signal, wherein the first and second pixels have a symmetrical arrangement by referring the second signal line as a symmetrical axis.

18. The display apparatus according to claim 15, further comprising a second signal line configured to transmit the second control signal, wherein the first and second pixels have a symmetrical arrangement by referring the second signal line as a symmetrical axis.

19. A driving method for a display apparatus, the display apparatus comprising a first pixel and a second pixel, both of the first and second pixels comprising a first transistor, a second transistor and a light-emitting diode, the first transistor being configured to determine whether or not to allow a current to flow through the light-emitting diode in the respective pixel according to a first control signal, the second transistor being configured to control a magnitude of the current flowing through the light-emitting diode in the respective pixel according to a voltage difference between a gate and a source of the second transistor, the driving method comprising:
switching off, through the first control signal, the first transistors in the first and second pixels and thereby preventing a current from flowing through the light-emitting diodes in the first and second pixels;
driving the first pixel in a first period to configure the first pixel to receive a data signal of the first pixel;
driving the second pixel in a second period to configure the second pixel to receive a data signal of the second pixel, wherein the second period is different with the first period; and
driving the first and second pixels to emit light according to the data signals thereof, respectively.

20. The driving method according to claim 19, further comprising:
driving, through a second control signal, the first and second pixels to rest gate voltages of the second transistors in the first and second pixels respectively before the first and second periods.
